(19) United States
(12) Patent Application Publication
(10) Pub. No.: US 2006/0041901 A1
(43) Pub. Date: Feb. 23, 2006

(54) Disk cartridge and storage assembly

(75) Inventors: Bart Van Rompaey, Eindhoven (NL); Bob Van Someren, 's-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/531,928

(22) PCT Filed: Oct. 6, 2003
(86) PCT No.: PCT/IB03/04433

§ 371 Date: Apr. 19, 2005

(30) Foreign Application Priority Data
Oct. 22, 2002 (EP) 02079391.5

(51) Int. Cl. G11B 23/03

(52) U.S. Cl. 720/728

(57) ABSTRACT

A disk cartridge and storage assembly comprises an optical disk and a housing (2) in which the disk is rotatably accommodated. The housing is adapted to be inserted into a disk drive together with the disk. The cartridge comprises at least a first coupling member (5) on the housing. The assembly is provided with a link element (6) to couple the cartridge to a storage support. A second coupling member (9) is provided on the link element and is adapted to be removably coupled to the first coupling member. In this way it is possible to store or transport one or more disk cartridges in a convenient manner.

The present invention relates to a disk cartridge and storage assembly, and in particular to a cartridge and storage system for small-format optical disks.

A new generation of optical disks will be smaller than the usual CDs and will probably have a diameter in the range of 20-40 mm, i.e. small enough to carry it, for example, in a pocket. In order to protect such a small disk, it is housed in a housing to form a cartridge so that it is protected against scratches and dust. One of the main applications of these small disks is the use in portable devices such as mobile phones, PDAs, notebooks, and the like. In view of this application, there is a need for means to store and transport one or more of said disk cartridges.

The object of the present invention is therefore to provide such a disk cartridge and storage assembly.

To achieve this object the present invention provides a disk cartridge and storage assembly which comprises:

a disk having two sides, at least one of the sides being adapted to contain readable data thereon;

a housing in which the disk is rotatably accommodated and which has an opening to provide access to the disk, the housing being adapted to be inserted into a disk drive together with the disk;

wherein the cartridge comprises at least a first coupling member on the housing, and the assembly is provided with a link element to couple the cartridge to a storage support, said link element comprising a second coupling member adapted to be removably coupled to the first coupling member.

This link element renders it possible to couple the cartridge to a storage support. This storage support may be adapted to couple one disk cartridge or several disk cartridges thereto. The storage support may be, for example, a key fob adapted to carry one disk cartridge. Another embodiment of the storage support is a container adapted to contain several cartridges in a coupled manner.

In one embodiment of the assembly, the first coupling member on the cartridge is at least one hole, for example a through-hole, made in a part of the housing outside the circumference of the disk. If the shape of the housing is such that at least a protruding area thereof projects beyond the circumference of the disk, e.g. if the cartridge is rectangular, the first coupling member is positioned in the protruding area, which may have a smaller thickness than the remainder of the housing.

The second coupling member formed on the link element may comprise a clamping mechanism, for example with two resilient legs having, at the sides facing each other, oppositely directed protrusions that fit into the hole of the first coupling member from two sides of the housing, the legs being spaced from each other at the position of the protrusions by a distance substantially corresponding to or smaller than the thickness of the housing at the position of the first coupling member. This creates a system with which the link element can be quickly and easily be coupled and uncoupled to and from the disk cartridge. If the link element is made from metal, such as spring steel, for example, the legs can be made very thin. If the thickness of the cartridge in the area around the first coupling member is smaller than the thickness of the remainder of the cartridge, the dimensions can be made such that the legs of the link element do not protrude beyond the surface of the disk cartridge.

In an alternative embodiment of the link element, the clamping mechanism of the link element comprises two legs having a protrusion on one leg that fits through the through-hole of the first coupling member on the cartridge housing, and having an opening on the other leg that fits, and preferably snaps, around the protrusion on the other leg.

This creates a kind of locking mechanism securely holding the cartridge to the link element.

A combination of the embodiments of the clamping mechanism is also conceivable.

As was mentioned above, the storage support may be a storage container, and this storage container has a support member pivotally connecting at least one cartridge to the container through the link element. In one possible embodiment, the storage container is adapted to accommodate a plurality of disk cartridges connected to parallel support members supporting the cartridges such that it is possible to leaf through the cartridges. This makes it easy to select a cartridge from the container.

In an alternative embodiment, the support member is an element provided at the circumference of a (rotatable) column, wherein a plurality of support members is spaced around the circumference of the column in order to suspend a plurality of cartridges pivotally around the column through the link elements so as to form a Rolodex® type of storage facility. Such a storage support is mainly intended for stationary use.

The invention also relates to a storage system for storing a plurality of disk cartridges, a link element for connecting a housing of a disk cartridge to a support member, a disk cartridge, and a method of manufacturing a plurality of link elements. All these aspects of the invention are defined in the set of claims.

The invention will be explained in more detail with reference to the drawings showing exemplary embodiments of the invention in a very schematic way.

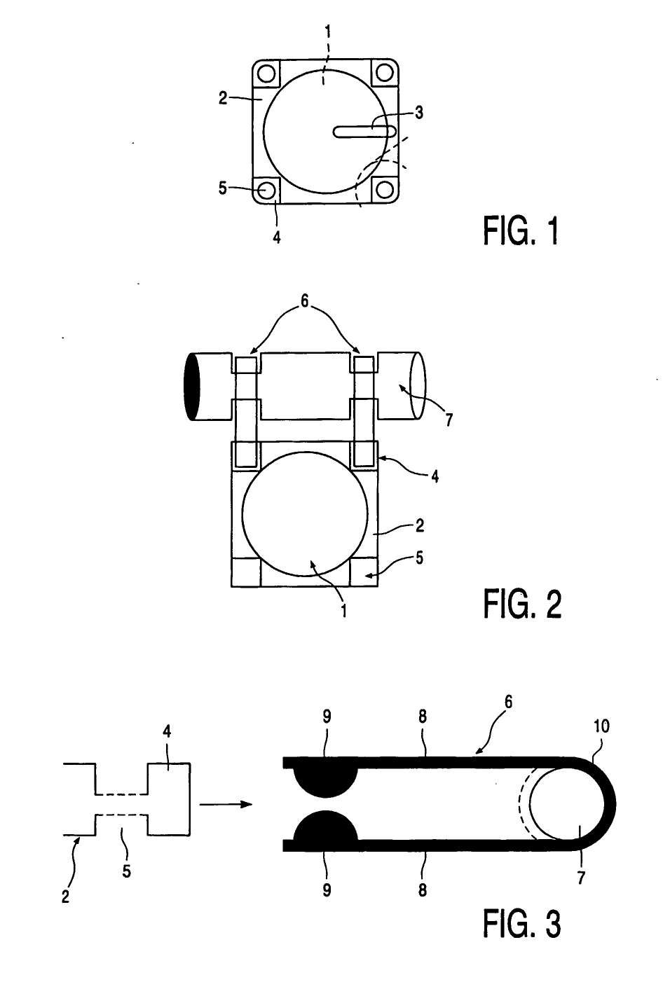

FIG. 1 is a very schematic plan view of an embodiment of the disk cartridge according to the invention.

FIG. 2 is a schematic plan view of a disk cartridge, link elements, and a support member according to the invention.

FIG. 3 is an enlarged sectional view taken on the line III-III in FIG. 2, in which, however, the link element is uncoupled from the disk cartridge.

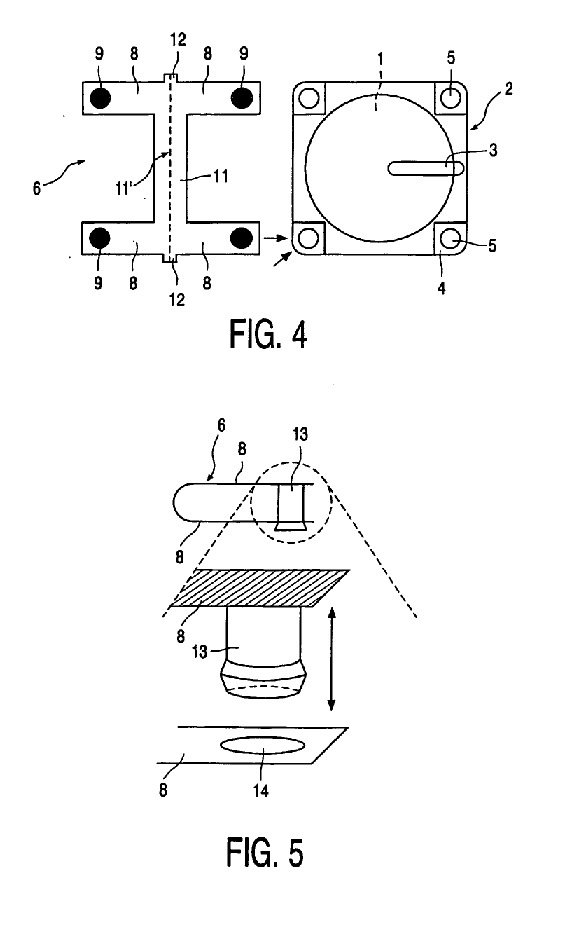

FIG. 4 is a plan view of the disk cartridge of FIG. 1 and a further embodiment of a link element according to the invention.

FIG. 5 is a side view of an alternative embodiment of a link element, and the detail of FIG. 5 is a perspective view of a second coupling member thereof.

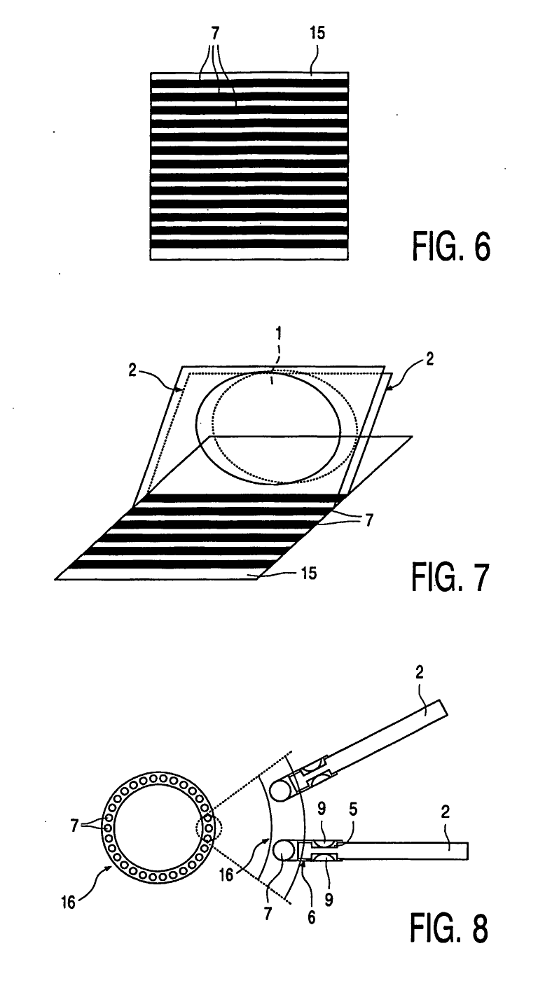

FIG. 6 is a plan view of the bottom of a storage container for storing a plurality of disk cartridges.

FIG. 7 is a perspective view of the bottom of the storage container of FIG. 6 and two disk cartridges coupled thereto.

FIG. 8 is a plan view of a Rolodex® type storage support, and an enlarged detail shows two disk cartridges connected to the support members of the storage support.

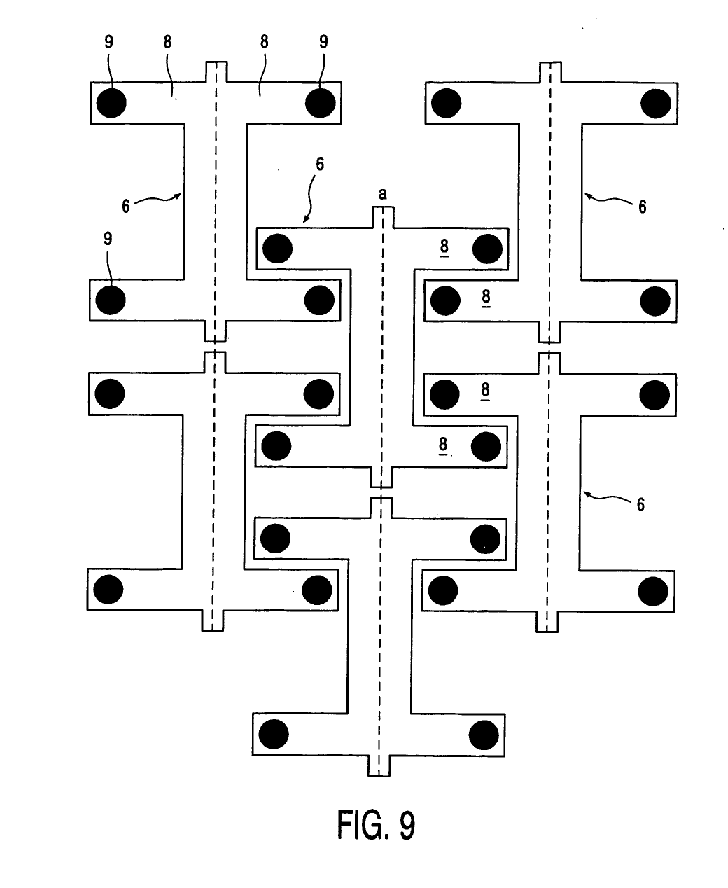

FIG. 9 is a plan view of a plurality of link elements according to the embodiment of FIG. 4, shown in the mutual positions in which they are cut from sheet material, in order to illustrate the method of manufacturing an embodiment of a link element for a disk cartridge containing a readable and/or writable disk.

In this description, the term cartridge is used for a combination of a disk and a housing in which the disk is accommodated, in this example irremovably accommodated. In use, the disk is inserted into the disk drive unit together with the housing. The disk will be exposed at least partially to a reading/writing head in the disk drive unit.

The cartridge according to the invention comprises a disk 1. The disk 1 is preferably an optical disk, but may also contain data which is readable or writable in another manner such as magnetically or the like. Disk 1 has two sides of which at least one side contains readable data thereon, or has at least one side comprising an area on which data can be written.

The disk 1 is contained in a housing 2 in which the disk 1 is rotatably accommodated and which has a (closable) access opening 3 to provide access to the disk, for example for a head of a disk drive into which the cartridge housing 2 can be inserted. The cartridge housing 2 is slightly larger than the diameter of the disk 1 therein. For example, the diameter of the disk 1 is ca. 30 mm, whereas the size of the (square) housing is ca. 32 mm.

Because of the shape of the housing 2, there is at least one corner area 4 where the housing 2 extends substantially beyond the circumference of the disk 1. The housing is square in the embodiment shown, and there are four corner areas 4. In these corner areas 4 are created first coupling members 5, in this case each shaped as a through-hole extending perpendicularly to the main plane of the housing 2. As an alternative the hole may be blind or may be interrupted, whereby two blind holes are created on opposite sides of the housing 2. Other embodiments of the first coupling members are obviously possible. The drawing does not show that the thickness of the housing 2 in the corner areas 4 may be slightly smaller than the thickness in the remaining area of the cartridge housing 2. The coupling members 5 may also be used to position a disk cartridge within a disk drive unit.

FIGS. 2 and 3 show the housing 2 of the cartridge together with a link element 6 and a support member 7. The link element 6 connects the housing 2 of the disk cartridge to the support member 7 which may be part of a storage support, such as a container, column, key fob, or the like.

In this embodiment, the link element 6 comprises two resilient legs 8 having a second coupling member 9 adapted to co-operate with the first coupling member 5 on the cartridge housing 2 at one end. In this case, the second coupling member 9 is constructed as two oppositely directed protrusions formed at one end of the link element 6 on the sides of the legs 8 that face each other. The protrusions 9 fit into the hole of the first coupling member 5 on the cartridge housing 2 from two sides thereof. Furthermore, the legs 8 of the link element 6 are spaced from each other at the position of the protrusions 9 by a distance substantially corresponding to or smaller than the thickness of the housing 2 in the corner areas 4. In this way, the housing 2 can be clamped between the legs 8 of the link element 6 with the protrusions 9 engaged in the hole 5, thereby coupling the link element 6 to the cartridge housing 2. Opening the legs 8 against a spring force of the legs 8 allows the link element 6 to be removed from the cartridge housing 2. To obtain a convenient resiliency in the legs 8 of the link element 6 and to create a link element 6 having a small thickness, it is preferred to manufacture the link element 6 from metal, such as spring steel.

In the embodiment shown, the legs 8 of the link element 6 are interconnected by a connecting part 10 which is shaped so as to be clamped around a diminished portion of the cylindrical rod that acts as the support member 7. If two link elements 6 are used to connect the cartridge housing 2 to the support member 7, the housing will only be pivotable about the axis of the support member 7.

FIG. 4 shows an alternative embodiment of a link element 6. In this embodiment, the link element 6 has two pairs of legs 8 connected by a bridge member 11 connecting the pairs of legs 8 at such distance that the second coupling members 9 on both pairs of legs 8 can be simultaneously coupled to the first coupling members 5 at two corner areas 4 of the cartridge housing 2. In line with the bridge member 11 there are formed two rotary members 12 projecting beyond the legs 8 and adapted to engage rotatably in recesses acting as the support member 7 of a storage support for the cartridge which is coupled to the link element(s) 6. The link element 6 is shown in flat, unfolded condition, but in use the link element 6 will be folded at the axis 11′ of the bridge member 11, such that the legs 8 of a pair will have a similar relative position as in the embodiment of FIGS. 2, 3.

FIG. 5 shows a further alternative embodiment of the link element 6 in which one leg 8, on its side facing the other leg 8, is provided with a protrusion 13, whereas the other leg 8 comprises an opening 14 positioned opposite the protrusion 13 and adapted to engage the protrusion 13, preferably in a snapping manner so as to form a lock. The protrusion 13 is dimensioned so as to fit through the first coupling member 5 of the cartridge housing 2, which, in this case, is constructed as a through-hole. This way of coupling the link element 6 to the cartridge housing 2 provides a safer coupling, which is convenient, for example, if the cartridge housing 2 is to be coupled to a key fob.

FIGS. 6 and 7 show an embodiment of a storage support in the form of a container bottom 15. The container bottom 15 is a part of a container or case adapted to accommodate a plurality of disk cartridge housings 2. The container bottom 15 comprises a plurality of support members 7 in the form of connecting rods, recesses, or other means for connecting link elements 6 to the storage support, i.e. the container bottom 15. In this case there is a plurality of parallel support members 7, preferably at such a distance from each other that there is sufficient distance between adjacent cartridge housings 2 to pivot them through a limited angle in order to be able to leaf though the cartridges. This enables a user to read titles on the cartridges and to make a selection therefrom.

FIG. 8 illustrates a further embodiment of a storage support in the form of a column 16, which is preferably rotatable and for stationary use, for example on a desk or the like. The column 16 comprises a plurality of support members 7 distributed around the circumference of the column 16. The support members 7 are positioned parallel to each other so that the cartridges are connected to the column 16 in a fan-like manner, while they are allowed to pivot through a limited angle around the corresponding support member 7. This allows a user to leaf through a series of cartridge housings 2. The column 16 may be positioned with its axis horizontally or vertically.

FIG. 9 shows a plurality of link elements 6 in the embodiment of FIG. 4. FIG. 9 illustrates the manner in which a plurality of link elements 6 is cut from a metal sheet during their manufacture. Three rows of link elements 6 are shown which are staggered lengthwise in order to allow the legs 8 of adjacent rows of link elements 6 to overlap so as to make maximum use of the sheet material. The second coupling members 9 are each formed as an indentation which is pressed into the metal sheet, either before or after they have been cut from the sheet. After the link elements 6 have been cut out and the second coupling members 9 have been pressed, the link elements are folded about a folding line along the central axis of the bridge member 11, i.e. along a line of symmetry of the link element 6. The folding operation shapes and adapts the two pairs of legs 8 so as to engage a cartridge housing 2 by means of the second coupling members 9.

It will be clear from the forgoing description that the invention provides a disk cartridge and storage assembly which is simple and which allows a convenient storage/transport of one or more disk cartridges. The coupling members enable a quick connection/disconnection of the cartridge with respect to the link element/storage support.

The invention is not restricted to the above embodiment shown in the drawing, which can be varied in several ways without departing from the scope of the invention. Embodiments shown or described may be combined, and separate features of the invention may be used in different combinations of features. For example, the shape of the cartridge housing may be varied, e.g. may be partly circular, and partly non-circular, such that a protruding area is formed.

1. A disk cartridge and storage assembly, comprising:
a disk having two sides, at least one of the sides being adapted to contain readable data thereon;
a housing in which the disk is rotatably accommodated and which has an opening to provide access to the disk, the housing being adapted to be inserted into a disk drive together with the disk;
wherein the cartridge comprises at least a first coupling member on the housing, and the assembly is provided with a link element to couple the cartridge to a storage support, said link element comprising a second coupling member adapted to be removably coupled to the first coupling member.

2. The assembly of claim 1, wherein the first coupling member on the cartridge is at least one hole made in a part of the housing outside the circumference of the disk.

3. The assembly of claim 2, wherein the hole is a through-hole.

4. The assembly of claim 2, wherein the shape of the housing is such that at least one protruding area thereof projects beyond the circumference of the disk, the first coupling member being positioned in the protruding area.

5. The assembly of claim 4, wherein said protruding area has a smaller thickness than the remainder of the housing.

6. The assembly of claim 1, wherein the second coupling member of the link element comprises a clamping mechanism.

7. The assembly of claim 6, wherein the clamping mechanism of the link element comprises two resilient legs having, at the sides facing each other, oppositely directed protrusions that fit into the hole of the first coupling member from two sides of the housing, the legs being spaced from each other at the position of the protrusions by a distance substantially corresponding to or smaller than the thickness of the housing at the position of the first coupling member.

8. The assembly of claim 6, wherein the clamping mechanism of the link element comprises two legs having a protrusion on one leg that fits through the through hole of the first coupling member on the cartridge housing and an opening on the other leg that fits around the protrusion on the other leg.

9. The assembly of claim 1, wherein an end of the link element remote from the second coupling member is adapted to be connected to a support member of the storage support.

10. The assembly of claim 9, wherein the support member is a key fob.

11. The assembly of claim 9, wherein the support member is an element provided in a storage container to connect at least one cartridge to the container in a pivotable manner by means of the link element.

12. The assembly of claim 9, wherein the support member is an element provided at the circumference of a column, and wherein a plurality of support members is provided spaced around the circumference of the column in order to suspend a plurality of cartridges pivotally around the column by means of the link elements so as to form a Rolodex® type of storage facility.

13. The assembly of claim 9, wherein the link element comprises two pairs of legs, each leg having a second coupling member adapted to be coupled to a respective first coupling member on the housing of the cartridge, said two pairs of legs being interconnected by a bridge member.

14. The assembly of claim 13, wherein the bridge member is provided with rotary members rotatably engaging in recesses that act as the support member for the cartridge.

15. A storage system for storing a plurality of disk cartridges, comprising a body, a plurality of support members distributed along the body, and a plurality of link elements pivotally connected to a corresponding support member, each link element having a second coupling member which is adapted to be removably coupled to a mating first coupling member of a cartridge.

16. The storage system of claim 15, wherein the body is a container in which the support members are provided in a series near a bottom of the container.

17. The storage system of claim 15, wherein the body is a column, the support members being distributed around the circumference of the column.

18. The storage system of claim 16, wherein the support members are arranged to suspend the cartridges in a parallel manner, the spacing of two adjacent support members being such that cartridges that are pivotally connected to the support members by means of the link elements are pivotable through a limited angle to enable a user to leaf through the series of cartridges.

19. Link element for connecting a housing of a disk cartridge to a support member, the link element comprising a second coupling member adapted to be removably coupled to a mating first coupling member on the housing of the disk cartridge.

20. The link element of claim 19, wherein the second coupling member is a clamping mechanism.

21. The link element of claim 20, intended to be coupled to a cartridge housing having a first coupling member constructed as a hole, wherein the clamping mechanism of the second coupling member comprises two resilient legs having, at the sides facing each other, oppositely directed protrusions that fit into the hole of the first coupling member from two sides of the housing, the legs being spaced from each other at the position of the protrusions by a distance substantially corresponding to the thickness of the housing at the position of the first coupling member.

22. The link element of claim 20, intended to be coupled to a cartridge housing having a first coupling member constructed as a hole, wherein the clamping mechanism comprises two legs having a protrusion on one leg that fits through the through hole of the first coupling member on the housing and an opening on the other leg that fits around the protrusion on the other leg.

23. The link element of claim 19, wherein the end of the link element remote from the second coupling member is adapted to be connected to a support member.

24. The link element of claim 19, comprising at least two second coupling members each adapted to be coupled to a respective first coupling member on the housing of the cartridge, said two coupling members being interconnected by a bridge member.

25. The link element of claim 24, wherein the bridge member comprises rotary members rotatably engaging in recesses acting as a support member for the cartridge.

26. The link element of claim 19, which is made from sheet metal, preferably spring steel.

27. The link element of claim 26, wherein the second coupling members are formed by protrusions, in particular stamped portions, adapted to engage in holes forming the first coupling members in the cartridge housing.

28. A disk cartridge, comprising:
a disk having two sides, at least one of the sides containing readable data thereon;
a housing in which the disk is rotatably accommodated and which has an opening to provide access to the disk, the housing being adapted to be inserted into a disk drive together with the disk;
wherein the cartridge comprises at least a first coupling member on the housing, adapted to be removably coupled to a second coupling member.

29. The disk cartridge of claim 28, wherein the shape of the housing is such that at least a corner area thereof projects beyond the circumference of the disk, and the first coupling member is at least one hole made in said corner area, preferably having a smaller thickness than the remainder of the housing.

30. Method of manufacturing a plurality of link elements comprising two pairs of legs which each comprise a second coupling member, and a bridge member between the pairs of legs, wherein the link elements are cut from flat metal sheeting, rows of link elements being cut out such that the link elements in adjacent rows are staggered and legs from link elements in one row are positioned between legs of link elements in an adjacent row.

31. The method of claim 30, wherein the link elements are folded from their flat position along a centerline through the bridge member, such that the legs in one pair are spaced from each other, and the second coupling members of the legs in one pair are mutually opposed.

32. The method of claim 31, wherein the second coupling members are each formed as an indentation which is pressed into the metal sheet before the link element is folded.

33. The method of claim 32, wherein the indentations are provided with a hemi-spherical shape.
